(19) United States
(12) Patent Application Publication
(10) Pub. No.: US 2012/0179988 A1
(43) Pub. Date: Jul. 12, 2012

(54) METHOD AND APPARATUS FOR SELECTING ICON THROUGH GROUPING

(75) Inventors: Jung-soo SUH, Suwon-si (KR); Charm-han KO, Suwon-si (KR)

(73) Assignee: SAMSUNG ELECTRONICS CO., LTD., Suwon-si (KR)

(21) Appl. No.: 13/286,559

(22) Filed: Nov. 1, 2011

(30) Foreign Application Priority Data
Jan. 11, 2011 (KR) 10-2011-0002795

(51) Int. Cl. G06F 3/048

(52) U.S. Cl. 715/767

(57) ABSTRACT

A method for selecting an icon through grouping, according to an exemplary embodiment, includes grouping a plurality of displayed icons into a plurality of groups according to a user's selection, allocating a different key of a plurality of keys on a remote controller to each one of the plurality of groups according to the user's selection, receiving a user's key selection signal corresponding to one of the plurality of keys which corresponds to one of the plurality of groups, moving a selection area from a current icon to a focus icon of a group including an icon desired by the user according to the user's key selection signal, moving the selection area from the focus icon to the desired icon according to an input of at least one direction key on the remote controller and selecting the desired icon.

### CROSS-REFERENCE TO RELATED APPLICATIONS

This application claims priority from Korean Patent Application No. 2011-0002795, filed in the Korean Intellectual Property Office on Jan. 11, 2011, the disclosure of which is incorporated herein by reference in its entirety.

### BACKGROUND

1. Field

Aspects of the exemplary embodiments relate to a method and an apparatus for selecting an icon provided by a user interface, and more particularly, to a method and an apparatus for selecting an icon through grouping of icons by a user.

2. Description of the Related Art

An apparatus supporting user interface provides a growing number of icons which can be selected by a user. In the case of icons provided on a screen that supports a matrix-type On Screen Display (OSD), an icon is moved one by one according to each input of a key on a remote controller as illustrated in FIG. 1, which may cause inconvenience to a user.

For example, as illustrated in FIG. 1, in order to select icon B by moving a cursor from icon A to icon B, a user has to input a key on the remote controller as many as seven times.

In other words, a user should input several keys on a remote controller to select an icon which is far away on an OSD on which a plurality of icons are arranged.

### SUMMARY

An aspect of the exemplary embodiments relates to a method and an apparatus for selecting an icon through grouping so as to make it easier to select an icon with a lesser number of key inputs.

A method for selecting an icon through grouping, according to an exemplary embodiment, includes grouping a plurality of displayed icons flexibly according to a user's selection, allocating a different key on a remote controller to each group according to the user's selection, moving a selection area to a focus icon of a group including an icon desired by the user according to the user's key selection signal, and moving the selection area from the focus icon to the desired icon according to an input of a direction key on a remote controller.

The plurality of icons may be menu icons on an on-screen display (OSD) or keyboard icons on an on-screen keyboard (OSK).

The grouping may include setting a number of groups and a grouping area by the user.

The number of groups may be set by a number key on the remote controller, and the grouping area may be set by a direction key on the remote controller.

The grouping area may have at least one circular, rectangular, triangle, and diamond shapes.

A different key on the remote controller may be a different number key, a different direction key, or other different keys on the remote controller.

The focus icon may be located at a center of a group including the focus icon.

An apparatus for selecting an icon through grouping, according to an exemplary embodiment, includes a display unit which provides a screen for grouping a plurality of displayed icons flexibly and provides a key allocating menu so that a different key on a remote controller is allocated to each group, a user input receiving unit which receives a user's input so that a plurality of displayed icons is grouped flexibly and a different key on a remote controller is allocated to each group, and a control unit which moves a selection area to a focus icon of a group including an icon desired by the user according to the user's key selection signal and moves the selection area from the focus icon to the desired icon according to an input of a direction key on a remote controller.

The plurality of icons may be menu icons on an OSD or keyboard icons on an OSK.

The screen for grouping may include a screen for the user to set a number of groups and a grouping area.

The number of groups may be set by a number key on the remote controller, and the grouping area may be set by a direction key on the remote controller.

The grouping area may have at least one circular, rectangular, triangle, and diamond shapes.

A different key on the remote controller may be a different number key, a different direction key, or other different keys on the remote controller.

The focus icon may be located at a center of a group including the focus icon.

According to various exemplary embodiments, the number of key inputs for moving a selection area to select a desired icon may be reduced.

### BRIEF DESCRIPTION OF THE DRAWINGS

The above and/or other aspects of the present disclosure will be more apparent by describing certain present disclosure with reference to the accompanying drawings, in which:

FIG. 1 is a view to explain an example in which key inputs are made among icons displayed on a related art on-screen display;

FIG. 2 is a schematic block diagram of an apparatus for selecting an icon through grouping according to an exemplary embodiment;

FIGS. 3 and 4 are views illustrating examples of setting a number of groups and a grouping area applied to menu icons on an on-screen display;

FIG. 5 is a view illustrating an example where a plurality of icons are applied to an on-screen keyboard;

FIGS. 6 to 8 are views to explain examples of various shapes of grouping areas to which an apparatus for selecting an icon through grouping is applied according to an exemplary embodiment;

FIG. 9 is a view to explain an example where a different key on a remote controller is allocated when a grouping area is divided into four portions;

FIG. 10 is a view to explain an example where a remote controller key allocated in FIG. 9 matches with the four divided grouping areas respectively; and

FIG. 11 is a flowchart illustrating a method for selecting an icon through grouping according to an exemplary embodiment.

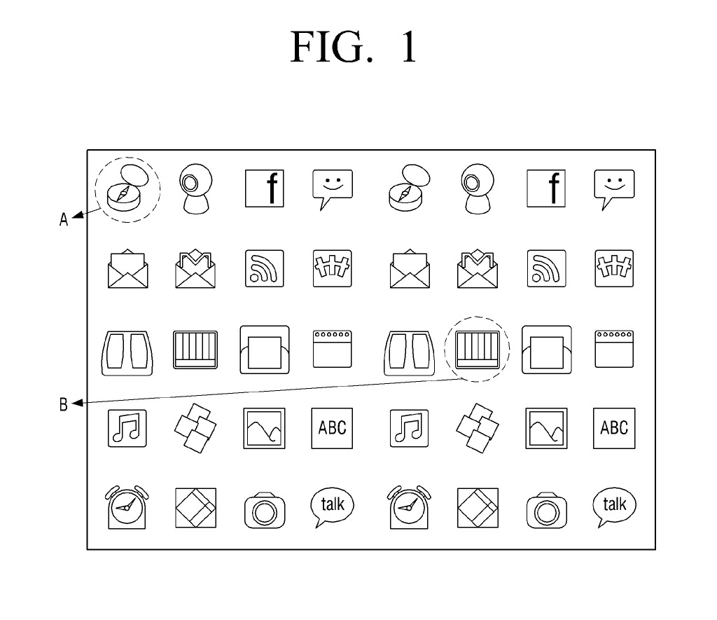

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

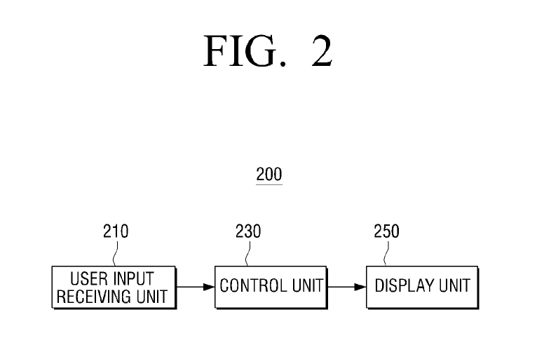

FIG. 2 is a schematic block diagram of an apparatus for selecting an icon through grouping according to an exemplary embodiment. As illustrated in FIG. 2, the selecting apparatus 200 which selects an icon through grouping includes a user input receiving unit 210, a control unit 230, and a display unit 250. The selecting apparatus 200 includes at least one processor, and each of the user input receiving unit 210, the control unit 230, and the display unit 250 may include its own processor.

The user input receiving unit 210 sets a plurality of icons displayed on the display unit to be flexibly grouped and receives a user input so that a different key on a remote controller is allocated to each of the groups. That is, the plurality of icons can be grouped in any manner deemed convenient by the user, and, after the groups have been set, different keys on a remote controller are configured or programmed to correspond to each of the groups. One icon in each group is designated as a focus icon (to be described later).

Herein, the plurality of icons may be menu icons on an OSD or keyboard icons on an On Screen Keyboard (OSK).

That is, the plurality of icons may be menu icons displayed on a display apparatus such as a television in the form of an OSD or keyboard icons of an OSK.

The control unit 230 moves a selection area (or a cursor) immediately to a focus icon of a group corresponding to a user's number key selection signal received through the user input receiving unit 210, and controls the display unit 250 to move the selection area according to a direction key input signal received through the user input receiving unit 210.

Herein, the focus icon may be located at the center of a group including the focus icon.

The display unit 250 provides a screen for flexibly grouping a plurality of displayed icons, and provides a menu for allocating a different key to each group.

Herein, the screen for setting groups may include a screen for allowing a user to set the number of groups and a grouping area.

The number of groups may be set by a number key on a remote controller, and the grouping area may be set by a direction key on a remote controller.

The shape of a grouping area may be one of a circle, a rectangle, a triangle, a diamond, etc.

Herein, the different key allocated to each group may be a number key, a direction key or other keys provided on the remote controller.

For example, a different key may be allocated to each group set by a user, and a key such as a number key and a direction key provided on a remote controller may be allocated to each group set by the user.

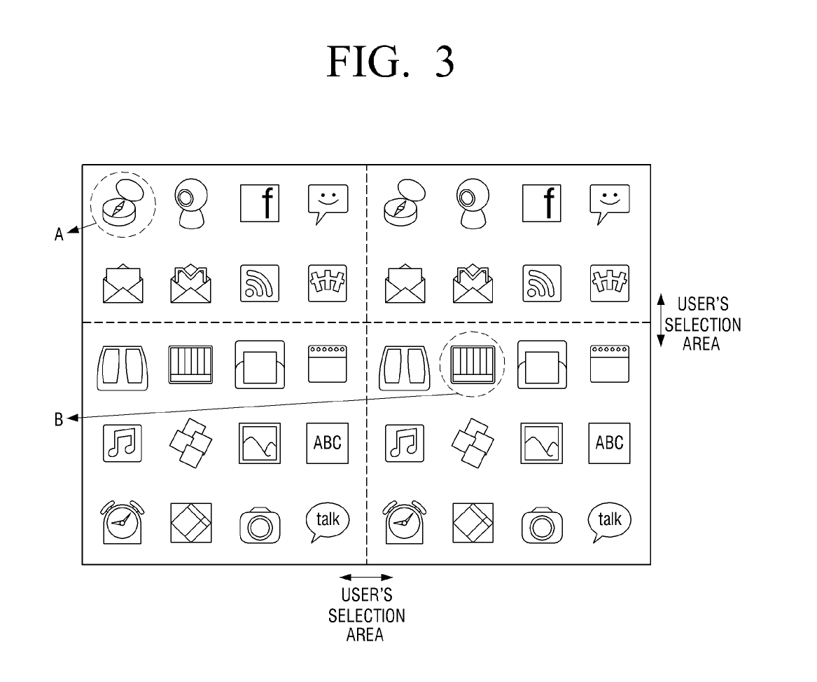

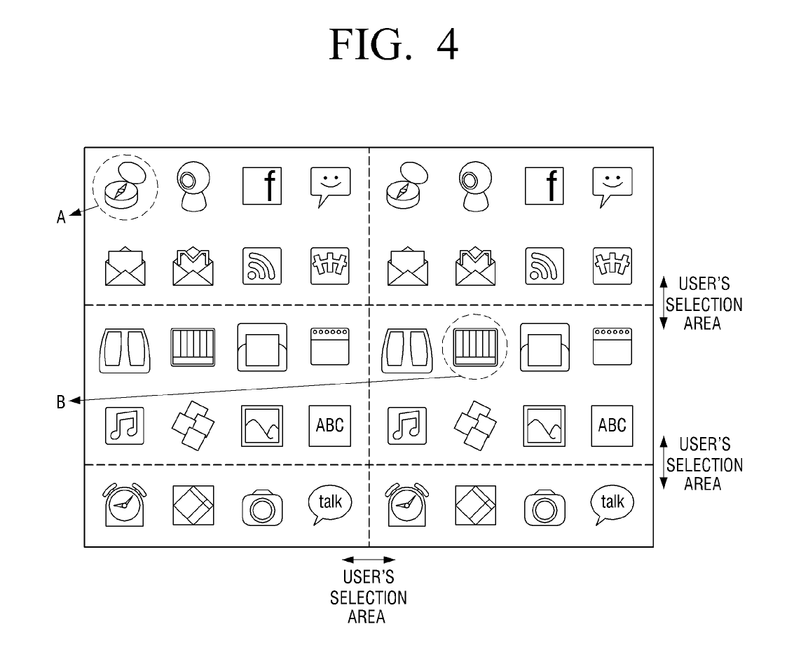

FIGS. 3 and 4 are views illustrating examples of setting the number of groups and a grouping area applied to menu icons on an OSD.

FIG. 3 illustrates an example of dividing menu icons on an OSD into four rectangular groups, and FIG. 4 illustrates an example of dividing menu icons on an OSD into six rectangular groups.

As illustrated in the above drawings, menu icons may be divided into various groups according to a user's selection, and the size of divided grouping area may also be set by a user.

For example, the number of groups may be set by a number key on a remote controller and the size of a grouping area may be set by a direction key on a remote controller. Accordingly, upon inputting a number of groups and a shape of the grouping areas, the control unit 230 divides the icons into groups having movable boundaries, and the direction keys on a remote may be used to move the movable boundaries to adjust the size of the grouping areas. The sizes of the grouping areas may be the same or different from each other.

Meanwhile, a plurality of icons illustrated in FIGS. 3 and 4 represent menu icons on an OSD, and a text explaining a corresponding icon may be added in an area surrounding the plurality of icons. The text is not illustrated for convenience of explanation.

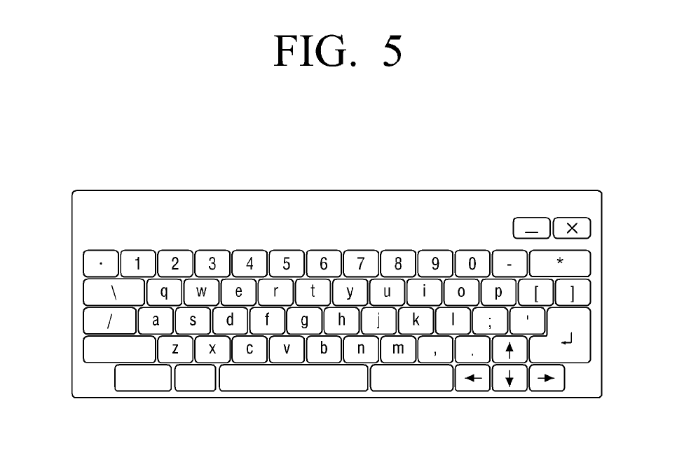

FIG. 5 is a view illustrating an example where a plurality of icons are applied to an on-screen keyboard (OSK).

The plurality of icons provided may be menu icons on an OSD illustrated in FIGS. 3 and 4, or may be keyboard icons on an OSK as illustrated in FIG. 5.

That is, the plurality of icons may be keyboard icons on an OSK which is displayed to input a text in a display apparatus using a remote controller such as a television.

The number of groups and the grouping area of the keyboard icons on an OSK may also be set according to a user's selection as illustrated in FIGS. 3 and 4.

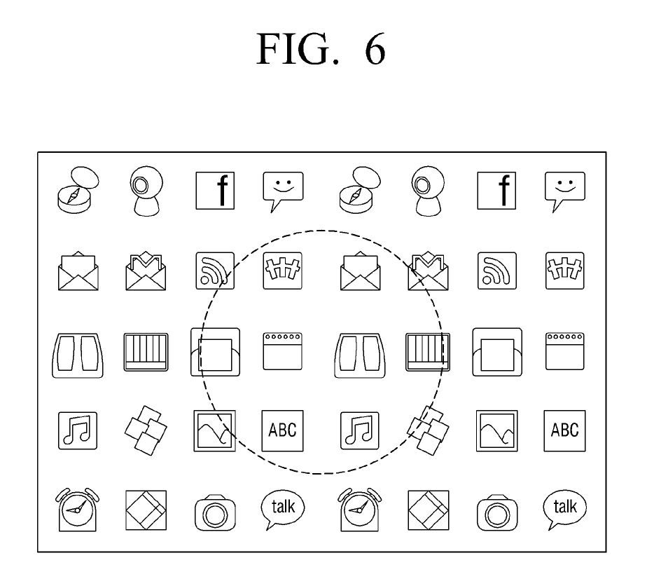

FIGS. 6 to 8 are views to explain examples of various shapes of grouping areas to which an apparatus for selecting an icon through grouping is applied according to an exemplary embodiment.

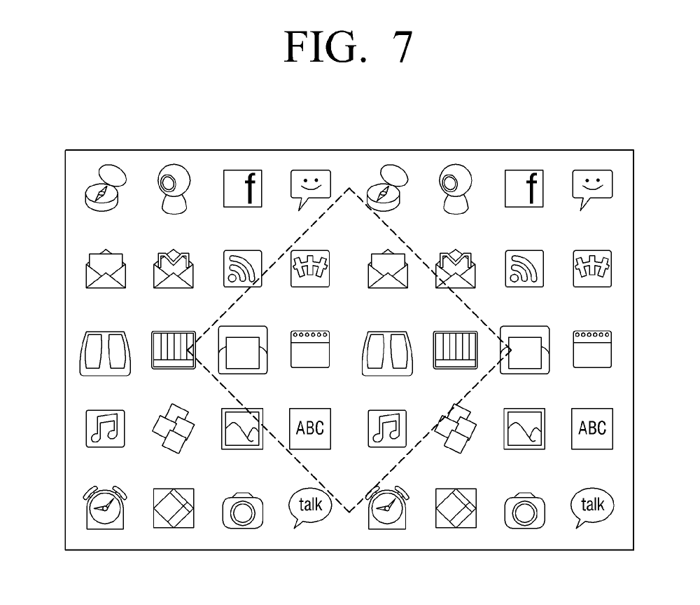

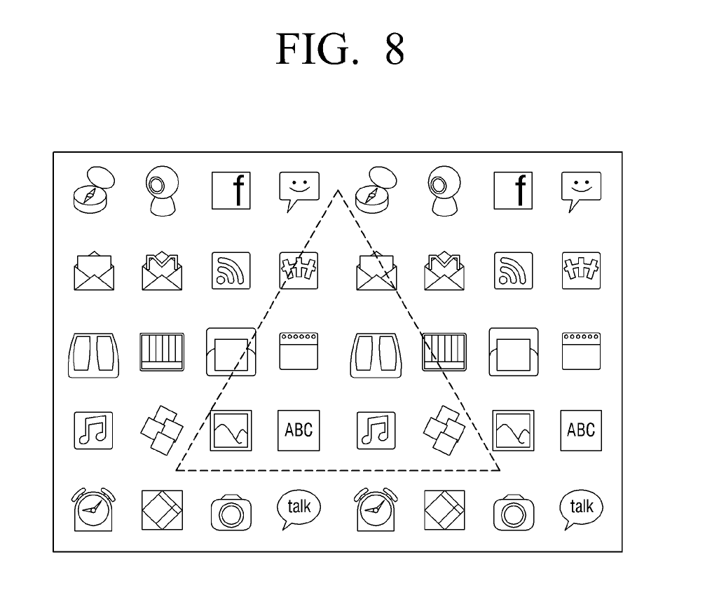

The shape of a grouping area may be circular as illustrated in FIG. 6, may be a diamond as illustrated in FIG. 7, or may be a triangle as illustrated in FIG. 8. However, the shape of a grouping area is not limited to the shapes in FIGS. 6 to 8, and there could be various shapes for the grouping areas.

In FIGS. 6 to 8, each group has the same shape, but this is only an example. Each grouping area may have a different shape, and a plurality of grouping areas may set to have the same grouping shape.

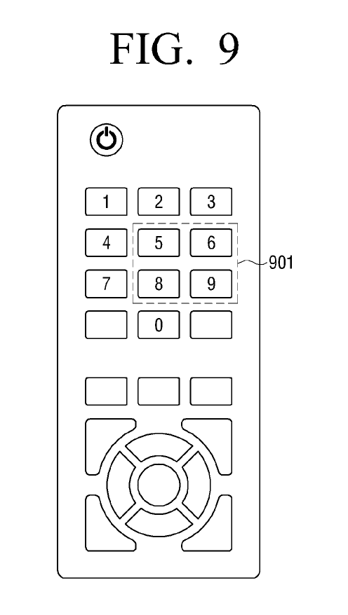

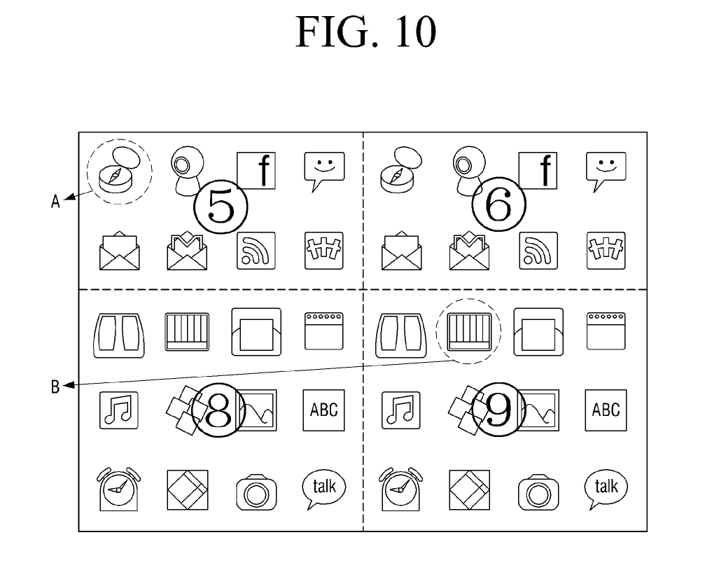

FIG. 9 is a view to explain an example where a different key on a remote controller is allocated when a grouping area is divided into four portions, and FIG. 10 is a view to explain an example where a remote controller key allocated in FIG. 9 matches with the four divided grouping areas respectively.

For example, if a plurality of icons illustrated in FIG. 3 are divided into four grouping areas, different keys of “5”, “6”, “8”, and “9” on a remote controller 901 may be allocated to each group as illustrated in FIG. 9, and thus it can be seen that the remote controller keys of “5”, “6”, “8”, and “9” are matched with the four grouping areas.

In the related art, in order to move a selection area from icon A to icon B, a user should continuously input direction keys. However, according to an exemplary embodiment, a user may move a selection area to icon B by inputting remote controller key “9” which is allocated to a grouping area including icon B and inputting direction keys to move the selection area from a focus icon to icon B.

Herein, a focus icon may be located at the center of a corresponding grouping area, but the location of a focus icon is not limited thereto. That is, the focus icon may be located at an arbitrary position of a corresponding grouping area and may be designated by a user or may be designated automatically by the control unit 230.

Accordingly, an apparatus for selecting an icon through grouping, according to an exemplary embodiment, divides a plurality of icons into a plurality of grouping areas according to a user's selection and allocates a different key of an input unit to each grouping area, thereby reducing the number of key inputs as a selection area instantly moves from one icon to a focus icon located in a corresponding grouping area, and a desired icon is selected as the selection area moves from the focus icon to the desired icon.

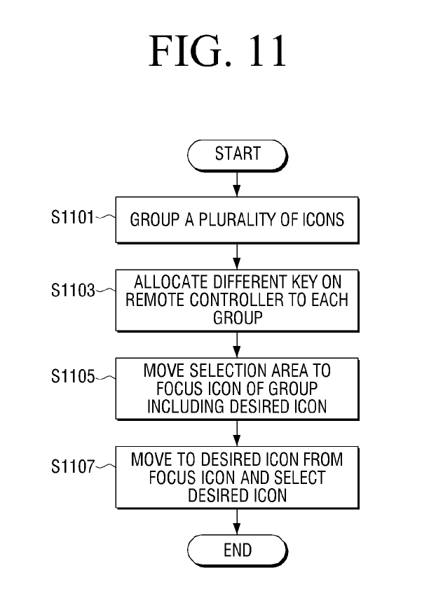

FIG. 11 is a flowchart illustrating a method for selecting an icon through grouping according to an exemplary embodiment.

Hereinafter, the overlapped description regarding an apparatus for selecting an icon through grouping will be omitted or provided briefly.

First, a plurality of displayed icons are grouped according to a user's selection Herein, the plurality of icons may be menu icons on an OSD or keyboard icons on an OSK.

In an exemplary embodiment, a user may set the number of groups and a grouping area in step S1101.

Herein, the number of groups may be set by a number key on a remote controller and a grouping area may be set by a direction key on a remote controller.

The shape of a grouping area may be one of circular, rectangular, triangle, and a diamond, but the shape is not limited thereto. There could be various shapes of a grouping area.

Subsequently, a different key on a remote controller is allocated to each group which is set according to a user's selection (S1103).

Herein, a different key on a remote controller may be a different number key, a different direction key, or other keys provided on a remote controller.

Subsequently, a selection area is moved to a focus icon of a group corresponding to a user's number key selection signal (S1105).

Herein, the focus icon may be located at the center of a group where the focus icon is included.

Lastly, the selection area is moved from the focus icon to an icon desired by a user according to a direction key on a remote controller input by a user (S1107).

Accordingly, an apparatus for selecting an icon through grouping, according to an exemplary embodiment, divides a plurality of icons into a plurality of grouping areas according to a user's selection and allocates a different key to each grouping area, thereby reducing the number of key inputs as a selection area instantly moves from one icon to a focus icon located in a corresponding grouping area and a desired icon is selected as the selection area moves from a focus icon to the desired icon.

Herein, the above-mentioned method of selecting an icon through grouping may be embodied as a program command executable through various computer means and recorded in a recording medium readable by a computer. In this case, the recording medium readable by a computer may include a program command, a data file, and data configuration alone or in combination. Meanwhile, the program command recorded in the recording medium may be exclusively designed and configured for the present invention or may be known to and commonly used by those skilled in the field of computer software industry.

The recording medium readable by a computer includes magnetic media such as a hard disk, a floppy disk, and a magnetic tape, optical media such as a CD-ROM and a DVD, magneto-optical media such as a floptical disk, and a hardware apparatus specially designed to store and perform a program command such as ROM, RAM, and a flash memory. Meanwhile, such a recording medium may be a transmission medium such as an optical or metal strip and waveguide including carrier wave which transmits a signal designating a program command, data configuration, and so forth.

In addition, the program command includes a machine code composed by a compiler and a high-level language code executable by a computer using an interpreter. The above-described hardware apparatus may be configured to operate as more than one software module to perform operations of the present invention and vice versa.

Although a few exemplary embodiments have been shown and described, it would be appreciated by those skilled in the art that changes may be made in these exemplary embodiments without departing from the principles and spirit of the invention, the scope of which is defined in the claims and their equivalents.

What is claimed is:

1. A method for selecting an icon through grouping, the method comprising:
grouping a plurality of displayed icons into a plurality of groups according to a user's selection;
allocating a different key of a plurality of keys on a remote controller to each of the plurality of groups according to the user's selection;
receiving a user's key selection signal corresponding to one of the plurality of keys which corresponds to one of the plurality of groups;
moving a selection area from a current icon to a focus icon of a group including an icon desired by the user according to the user's key selection signal; and
moving the selection area from the focus icon to the desired icon according to an input of at least one direction key on the remote controller.

2. The method as claimed in claim 1, wherein the plurality of icons are menu icons on an On-Screen Display or keyboard icons on an On-Screen Keyboard.

3. The method as claimed in claim 1, wherein the grouping comprises setting a number of groups and locations of boundaries of a plurality of grouping areas by the user's selection.

4. The method as claimed in claim 3, wherein the number of groups is set by a number key on the remote controller.

5. The method as claimed in claim 3, wherein the locations of the boundaries of the plurality of grouping areas are set by the at least one direction key on the remote controller.

6. The method as claimed in claim 3, wherein shapes of the plurality of grouping areas comprise at least one of a circular shape, a rectangular shape, a triangular shape, and a diamond shape.

7. The method as claimed in claim 1, wherein the plurality of keys on the remote controller which correspond to the plurality of groups are at least one of a plurality of different number keys and a plurality of different direction keys.

8. The method as claimed in claim 1, wherein the focus icon is located at a center of the group including the focus icon.

9. An apparatus for selecting an icon through grouping, the apparatus comprising:
a display unit which provides a screen for grouping a plurality of displayed icons into a plurality of groups and provides a key allocating menu so that a different key of a plurality of different keys on a remote controller is allocated to each of the plurality of groups;
a user input receiving unit which receives user input so that the plurality of displayed icons are grouped according to the user input and so that one of the plurality of different keys on the remote controller is allocated to each of the plurality of groups according to the user input; and
a control unit which receives a user's key selection signal corresponding to one of the plurality of different keys which corresponds to one of the plurality of groups, moves a selection area from a current icon to a focus icon of a group including an icon desired by the user according to the user's key selection signal, and moves the selection area from the focus icon to the desired icon according to an input of at least one direction key on the remote controller.

10. The apparatus as claimed in claim 9, wherein the plurality of icons are menu icons on an On-Screen Display or keyboard icons on an On-Screen Keyboard.

11. The apparatus as claimed in claim 9, wherein the screen for grouping includes a screen for the user to set a number of groups and locations of boundaries of a plurality of grouping areas.

12. The apparatus as claimed in claim 11, wherein the number of groups is set by a number key on the remote controller.

13. The apparatus as claimed in claim 11, wherein the locations of the boundaries of the grouping areas are set by the at least one direction key on the remote controller.

14. The apparatus as claimed in claim 11, wherein shapes of the plurality of grouping areas comprise at least one of a circular shape, a rectangular shape, a triangular shape, and a diamond shape.

15. The apparatus as claimed in claim 9, wherein the plurality of different keys on the remote controller which correspond to the plurality of groups are at least one of a plurality of different number keys and a plurality of different direction keys.

16. The apparatus as claimed in claim 9, wherein the focus icon is located at a center of the group including the focus icon.

17. A method for selecting an icon through grouping, the method comprising:
grouping a plurality of icons displayed on a screen into a plurality of groups, wherein each of the plurality of groups has a grouping area that is defined by a plurality of movable boundaries displayed on the screen;
allocating a different key of a plurality of keys on a remote controller to each of the plurality of groups;
designating a focus icon for one of the plurality of groups;
receiving a user's key selection signal corresponding to an input of one of the plurality of keys which corresponds to one of the plurality of groups;
instantly moving a selection area from a current icon to the focus icon located within the one of the plurality of groups that corresponds to the user's key selection signal; and
moving the selection area from the focus icon to a desired icon located in a same group as the focus icon according to an input of at least one direction key on the remote controller.
